(19) United States
(12) Patent Application Publication
(10) Pub. No.: US 2004/0091694 A1
(43) Pub. Date: May 13, 2004

(54) Induction bondable high-pressure laminate

(76) Inventors: Mark R. Holzer, Mason, OH (US); Philip L. Kropp, Loveland, OH (US)

Correspondence Address: Frost Brown Todd, LLC, 2200 PNC CENTER, 201 E. FIFTH STREET, CINCINNATI, OH, 45202, US

(21) Appl. No.: 10/630,270

(22) Filed: Jul. 30, 2003

Related U.S. Application Data
(60) Provisional application No. 60/399,997, filed on Jul. 31, 2002.

(51) Int. Cl. B32B 5/16

(52) U.S. Cl. 428/323; 428/537.5

(57) ABSTRACT

The present invention relates to novel high-pressure laminate constructions that can be bonded to a substrate through the use of electromagnetic energy. Specifically, high-pressure laminates are made which incorporate or have bonded thereto a susceptor element which absorbs electromagnetic energy, generating heat sufficient to melt or activate an intermediate adhesive for bonding the laminate to a substrate. In a preferred embodiment, the high-pressure laminates have a pre-applied heat sensitive adhesive.

### FIELD OF THE INVENTION

This invention relates to induction bondable high-pressure laminate constructions and methods for removing and applying high-pressure laminates using induction bonding.

### BACKGROUND OF THE INVENTION

High-pressure laminates are generally made from several layers of paper and/or fabric impregnated with a resin material that are consolidated under high pressure (1000 psi or more) and elevated temperatures, generally about 300° F. Most commonly, high-pressure laminates are made from Kraft paper impregnated with a phenolic resin. To provide decorative properties, as well as enhanced physical properties and/or durability, the high pressure laminates incorporate a top sheet, colored and/or imprinted with decorative patterns, impregnated with melamine resin, which cures under pressure and heat to a clear, hard finish. Alternatively, the decorative layer may consist of a metal sheet that is adhesively bonded to resin-impregnated paper as in EP 1182031. Oftentimes, a thin, plain, impregnated tissue-type sheet or a layer of resin with dispersed pre-cured particulates provide the final protective layer or overlayer (See O'Dell et. al. U.S. Pat. No. 5,545,476).

The finished high-pressure laminates find broad applications in the furniture and construction industries, the signage or display industry, and elsewhere. Because of their relative thinness and flexibility, they must be affixed or bonded to a support structure of greater rigidity, oftentimes a frame or work surface. For flooring, countertops, furniture and the like, the high-pressure laminate is typically bonded to the support structure with water-based adhesives, solvent-based contact adhesives, or hot melt adhesives. For temporary signage, the high-pressure laminate is typically attached to the support structure with mechanical fasteners or pressure-sensitive adhesive tapes.

There are several disadvantages to these bonding methods. Water-based adhesives have lengthy drying times and, depending upon the nature of the construction of the laminate, their use can lead to swelling/deformation and/or de-bonding as a result of water ingress into the paper or fiber of the layers of the laminate. Solvent-based adhesives require environmental and safety controls and use or coverage is limited to ensure solvent dissipation and avoid detrimental impact of the solvent on the laminate structure. Hot melt adhesives have short open times that limit workability. In the case of temporary signage, mechanical fasteners damage the substrate, while pressure-sensitive adhesive tape is weak, unattractive, and subject to creep. In addition, none of the methods for bonding laminate to countertops, furniture and the like, allow for removal and replacement of laminate after it has been adhesively bonded to the base. Water-based and solvent-based adhesives are typically not reversible or require very high heat to break the bond. Such elevated temperatures can damage the laminate rendering them non-reusable. Hot melt adhesives are reversible with moderate heat but there is no effective way to heat the adhesive through the laminate, as it is a poor conductor of heat. For example, application of a hot iron to the top surface of the laminate is very slow in raising the temperature of the hot melt adhesive on the bottom layer to a point where the laminate can be removed. Furthermore, such use of a hot iron risks damaging the laminate, especially the decorative surface, and also presents safety hazards to the user.

Remerowski et. al. (WO 98/05725) disclose a method of adhering construction materials, often referred to as sheet goods, to a work surface by placing adjacent to the surfaces to be joined an adhesive device comprising a target element contiguous with a heat activatable adhesive, the target element being absorbent of electromagnetic waves which are convertible to heat energy to activate the adhesive, holding the surfaces together and exposing the adhesive device to electromagnetic waves to activate the adhesive and effectuate the bond. In its typical embodiment, the adhesive device is placed on the work surface following which the sheet good is laid in place and the adhesive device activated. Little is said of the construction of the adhesive device and its activation.

There is a need for a simple to use, induction bondable high-pressure laminate that can be easily removed and securely attached to a support structure with little adverse effect on the laminate or support structure. In addition, there is a need in both the consumer D-I-Y market and professional market as well as in the OEM market for laminates which can merely be cut to size, placed and quickly affixed. There is especially a need for such laminates that have associated therewith a pre-applied adhesive so as to avoid the need for introducing messy adhesives, mechanical fasteners, and the like into the assembly process; particularly in OEM markets where problems with the adhesive dispenser/applicator can lead to the shut down of a complete manufacturing line. In following, there is also need for storage stable, ready-to-use induction bondable high-pressure laminates. Finally, there is also a need for such laminates having de-bonding ability so that neither the laminate nor the support structure is adversely affected. Examples of applications in which this need is readily apparent is in replacement of damaged tabletops, edge banding, column wraps, appliance fronts, push and kick plates, ceiling panels, wall panels, residential cabinetry, decorative trim and accents, and temporary installation of signs and store fixtures.

### SUMMARY OF THE INVENTION

The primary objective of the present invention is to provide an induction bondable high-pressure laminate comprising, in sequence, a decorative layer, a core layer and a susceptor layer. In a first iteration, the decorative layer and the core layer comprise a preformed high-pressure laminate to which the susceptor layer is adhered. In an alternate iteration, the susceptor layer is itself incorporated into the preformed high-pressure laminate. In both iterations, the susceptor layer may comprise a single susceptor element or a plurality of susceptor elements.

Another objective of the present invention is to provide a storage stable, ready to use, induction bondable high-pressure laminate having a pre-applied heat responsive adhesive. Such heat responsive adhesives are essentially tack-free at normal ambient temperatures; however, to ensure that laminates having the pre-applied adhesive can be stored in a stacked relationship without concern for premature bonding, the laminates may also have a release layer overlaying the pre-applied adhesive.

In accordance with the teachings of the present invention, there are provided methods by which the aforementioned laminates are made as well as methods by which the so formed induction bondable laminates are bonded to a support structure.

The present invention also provides a method for removing an induction bondable laminate from a support structure.

Finally, the present invention also pertains to devices that enable susceptors, otherwise hidden from view, to be readily and properly located for effecting installation or removal of an induction bondable high-pressure laminate.

### BRIEF DESCRIPTION OF THE DRAWINGS

FIG. 1 depicts a cross-sectional, break-out view of a high-pressure laminate construction wherein the susceptor is bonded to a preformed high-pressure laminate.

FIG. 2 depicts a cross-sectional, break-out view of a high-pressure laminate construction wherein the susceptor is incorporated into a preformed high-pressure laminate.

FIG. 3 depicts a cross-sectional, break-out view of a high-pressure laminate construction having an adhesive pre-applied to a preformed high-pressure laminate which has incorporated therein a susceptor.

FIG. 4 depicts the footprint of an induction coil used in effecting bonding of the induction bondable high-pressure laminates.

### DETAILED DESCRIPTION OF THE INVENTION

For the purpose of this disclosure and the appended claims, the term “induction bondable” means that the heat needed to activate the heat responsive adhesive material used to bond the laminates to the support structure is generated by exposure of the laminate construction to electromagnetic energy/-electromagnetic waves (collectively hereinafter “electromagnetic energy”). The heat itself may be a result of induction heating (i.e., by induced electric currents, e.g., eddy currents), hysteresis heating and/or microwave heating.

In accordance with the teaching of the present invention, there are provided induction bondable high-pressure laminates which are capable of being bonded to a substrate, typically a support structure (as referenced above), by use of a heat responsive adhesive wherein the energy for activation of the heat responsive adhesive is generated in situ, as a result of exposure of the inventive induction bondable high-pressure laminate construction to electromagnetic energy. More specifically, the present invention is directed to high-pressure laminate constructions having an electromagnetic energy absorbing susceptor material which, upon exposure to electromagnetic energy, absorbs such energy and converts the same to heat which is subsequently transferred to the heat responsive adhesive so as to activate the same. The susceptor material may be incorporated directly into the high-pressure laminate or adhesively bonded to a pre-formed high-pressure laminate.

High-pressure laminates, their construction and manufacture, are well known, especially to those skilled in the art. Almost any high-pressure laminate construction, and the components therefore, may be used in the practice of the present invention. Typically, high-pressure laminates comprise two key layers, a core layer and a decorative layer. Other layers, such as overlayers for providing enhanced physical, wear resistance, protective and/or visual properties or characteristics are oftentimes used as well.

The core layer is generally comprised of a plurality of resin impregnated paper and/or fabric sheets, especially paper sheets, each stacked one on top of the other. Typical laminates will have from 2 to 10 sheets. The most common and preferred sheet material used in making the laminates is Kraft paper. Suitable impregnation resins include, but are not limited to phenolic resins, melamine resins, resorcinolic resins, and urea resins.

The decorative layer overlays the core layer and comprises an impregnated sheet of paper or fabric as well but is most often colored and/or patterned so as to provide a decorative appearance. The impregnation resins may be the same as used in the core, but are more typically a melamine resin. In addition, other impregnation resins used for the decorative layer include resins and resin systems based on polyesters, curable acrylics, dicyandiamide-formaldehyde, epoxy, polyurethane and mixtures thereof.

Alternatively, the decorative layer may comprise a decorative metal layer as described in Krebs et. al. (EP 1182031), herein incorporated by reference; however, to the extent such metal layer may interfere with the absorption of electromagnetic energy by the susceptor layer or with the latter's ability to generate sufficient heat to activate the heat responsive adhesive, such should not be present. In particular, depending upon its electromagnetic energy absorption characteristics, if any, such metal layers may generate excess heat which could adversely affect the appearance of the high-pressure laminate. On the other hand, it is possible that a metallic decorative layer could beneficially modify the heating of the bottom layer of foil. For example, a decorative border of aluminum foil might improve edge heating and assist in the removal of the laminate. In general, though, it is preferred that the decorative layer not be a metal layer or, if such, one that does not interfere with laminate bonding. Most preferably, the decorative layer will have minimal if any electromagnetic energy absorption characteristics; otherwise, such metallic decorative layers should be avoided altogether.

In addition to the decorative layer and the core layer, high-pressure laminates oftentimes include a further impregnated overlayer or other protective overlayer material for providing enhanced physical, wear resistance, protective and/or visual properties or characteristics. In the case of an impregnated overlayer material, it is typical to use a tissue or other paper, including, preferably a Kraft paper overlayer impregnated with a melamine resin or such other resins mentioned above, especially as used with the decorative layer. Alternatively, or in addition, the overlayer may be a thick layer of a resin composition having contained or dispersed therein particles of cured resins and other filler materials as taught in O'Dell et. al. (U.S. Pat. No. 5,545,476), herein incorporated by reference.

Susceptor materials suitable for use in the construction of the laminates of the present invention include essentially any structural material capable of absorbing electromagnetic energy and converting such energy to heat. For example, the susceptor may be comprised of a carbon fabric or mesh or a metal or metallized material selected from foils, strips, sheets, fabrics and meshes. The foregoing may be in the form of a continuous, solid layer or they may have random or patterned slits, punch-outs or cutouts such that portions of the core laminate will be visible through the susceptor layer. Additionally, such susceptors may be of even thickness or varying thickness. Suitable susceptors of the foregoing type include those taught by Hansen et. al. in U.S. Pat. No. 5,500,511 and U.S. Pat. No. 5,705,796, which are incorporated herein by reference. Alternatively, the susceptor may comprise electromagnetic energy absorbing materials selected from ferrites, metallic flakes, chopped metallic fibers, chopped carbon fibers, carbon black powder, metallic powder, and metallized fibers, flakes or particles, especially carbon black and ferrites. These latter susceptor materials are preferably incorporated into a polymer matrix or binder, and are preferably applied as a preformed film.

Metals useful in the preparation of the susceptors include copper, steel, aluminum and other electrically conductive metals. The specific selection of the susceptor material and form of the susceptor material is dependent upon the electromagnetic energy source/type (e.g., microwave, low frequency, medium frequency, high frequency) and the type of heating desired (i.e. induced eddy currents, eddy current-hysteresis or hysteresis). For convenience, practicality, and safety, heating is preferably developed using low to medium frequency electromagnetic waves (˜2 kHz to ˜1 Mhz) by induced eddy currents alone or in combination with hysteresis heating. In this respect, it is preferred that the susceptor be in the form of a sheet, foil, or mesh, which may be perforated, non-perforated, or patterned, with or without a constant thickness, and made of aluminum.

As noted, when the susceptor is particulate in nature, e.g., particles, flakes, or fibers, they are preferably incorporated into a resin matrix or binder material. Suitable binder materials are those that allow electromagnetic energy to pass through and are not heat insulating nor heat degrading, at least at the temperatures to be generated by the susceptor particulates themselves. Suitable materials include silicone resins, polyethylene, and, where the susceptor is bonded to the laminate core, a hot melt adhesive or other solid (at room temperature), heat activatable adhesive. For ease of use, these materials may be applied to the construction as a hot melt or a preformed film.

Generally speaking, the susceptor or susceptor layer has a thickness of about 0.01-3 mils (0.00001″-0.003″) or more, preferably 0.01-2 mils, or most preferably 0.01-1 mils. In the case of eddy current induction, especially when aluminum foil is used, the thickness of the susceptor layer may be somewhat less, from 0.01-2 mils, preferably 0.010.75 mils, and most preferably 0.01-0.55 mils. Alternatively, where the susceptor comprises electromagnetic energy absorbing particulates in a matrix or binder, the thickness of the susceptor layer may be somewhat higher, on the order of 1 to 10 mils, preferably, 3 to 8 mils. In those instances where the matrix or binder is also the adhesive for bonding the laminate to the substrate, such that the susceptor layer is also the adhesive layer, the susceptor thickness will be on the order of that typical for the adhesive.

The specific selection of the susceptor material and form of the susceptor material is dependent, in part, upon the type of electromagnetic energy to which the laminate is exposed, e.g., low frequency, medium frequency, high frequency or microwave. For convenience, practicality, and safety, heating is preferably developed using low to medium frequency electromagnetic waves (˜2 kHz to ˜1 MHz) by induced eddy currents alone or in combination with hysteresis heating. In this respect, it is preferred that the susceptor be in the form of a sheet, foil, or mesh, which may be perforated, non-perforated, or patterned, with or without a constant thickness, and made of aluminum.

The susceptor layer may be continuous whereby the susceptor overlays the whole or substantially the whole of the lower surface of the laminate core. Alternatively, the susceptor layer may be discontinuous whereby a plurality of discrete susceptor elements or pieces overlay the lower surface of the laminate core in a patterned or random fashion. Depending upon the size of the high-pressure laminate and its intended end use, it may be more desirable and cost-effective to use a susceptor layer of the discontinuous type where the susceptor elements are arranged in a pattern for optimal bonding and, optionally, debonding properties.

Generally speaking, the thinner the susceptor element, the more efficient the heating process. High efficiency allows for greater bond area or reduced activation time for a fixed area. However, because of the delicate nature and the ease of tearing of the extremely thin films and foils which are used as the susceptor elements, it is preferable to bond the same to a support layer to provide integrity to the susceptor for handling. Typically, the support layer may be a polymer film, a fabric, tissue, non-woven scrims or a paper sheet, especially preferred are porous support materials that allow the resin to impregnate the support material as well, most preferably Kraft paper. For convenience and to avoid possible incompatibilities, especially where the susceptor layer is to be incorporated into the high-pressure laminate, it is desirable that the support layer be of the same material as the sheet materials comprising the core layer, especially Kraft paper. Additionally, the support layer may be an electromagnetic transparent, heat insulating material; provided that in use, the insulating layer is intermediate the susceptor element and the core layer. The susceptor element may be bonded to the support layer using any suitable adhesive, including those adhesives used to bond the whole of the structure to a substrate as further disclosed below.

The adhesive suitable for bonding the laminate to a substrate may be any of those conventionally used in bonding traditional high pressure laminates to a substrate or work surface, including, but not limited to, hot melts, thermoset adhesives, water-based adhesives and solvent-based adhesives, preferably a hot melt. The adhesive is typically applied to the base in liquid form but may also be applied as a dry film.

The preferred adhesive for bonding the induction bondable laminate to the substrate is typically a hot melt adhesive or a reactive hot melt adhesive. Such hot melt adhesives are generally solvent-free adhesives based upon a number of different chemistries including: ethylene vinyl acetate (EVA) copolymers, styrene-isoprene-styrene (SIS) copolymers, styrene-butadiene-styrene (SBS) copolymers; ethylene ethyl acrylate copolymers (EEA); polyvinyl acetates (PVA), polyethylene (PE), other ethylene copolymers, amorphous polypropylene block copolymers, block copolymers based on styrene and elastomeric segments or ether and amide segments, polyesters, polyamides and thermoplastic and reactive polyurethanes, with polyamides, polyolefins and ethylene/vinyl acetate copolymers being particularly preferred. Different hot melt adhesives have different ranges of temperature over which they are activated; however, many are characteristically solid at temperatures below 180 degrees F. (° F.) and low viscosity fluids above 180° F. that rapidly set upon cooling. Others have transition temperatures as low as about 150 degrees F.: of course the actual transition temperature of a given hot melt adhesive depends upon the chemistry of that particular adhesive.

Alternatively, the heat responsive adhesive may be a heat reactive or curable material based upon, among others, urethanes, epoxies, acrylics and phenolics, with acrylics and phenolics being particularly preferred because of their fast cure times.

The adhesive may be of varying or, preferably, uniform thickness. The specific thickness of the adhesive layer will depend upon the intended end use application, especially the surface characteristics of the support or substrate to which the high-pressure laminate is to be bonded. If the surface is not smooth then a thicker film may be desired to ensure full contact between the adhesive and the substrate surface, i.e. to fill any gaps that may otherwise exist. Thin films, generally from about 1 to 3 mils may be used for simple bonding to smooth surfaces; whereas thicker adhesive layers, generally on the order of about 10 to 200 mils, preferably 20 to 140 mils, more preferably 30 to 50 mils, will be needed for adherence to substrates of rugose or uneven surfaces.

The induction bondable high-pressure laminate constructions of the present invention are of two basic types. The first type employs traditional pre-formed, high-pressure laminates to which are bonded an electromagnetic energy absorbing susceptor, with our without a pre-applied adhesive. The second type involves incorporating the electromagnetic energy absorbing susceptor into the laminate assembly during the formation of the high-pressure laminate itself, such that the susceptor is integrated into the finished, high-pressure laminate. The latter may also have a pre-applied adhesive layer which could be applied during high pressure laminate formation or subsequent to formation.

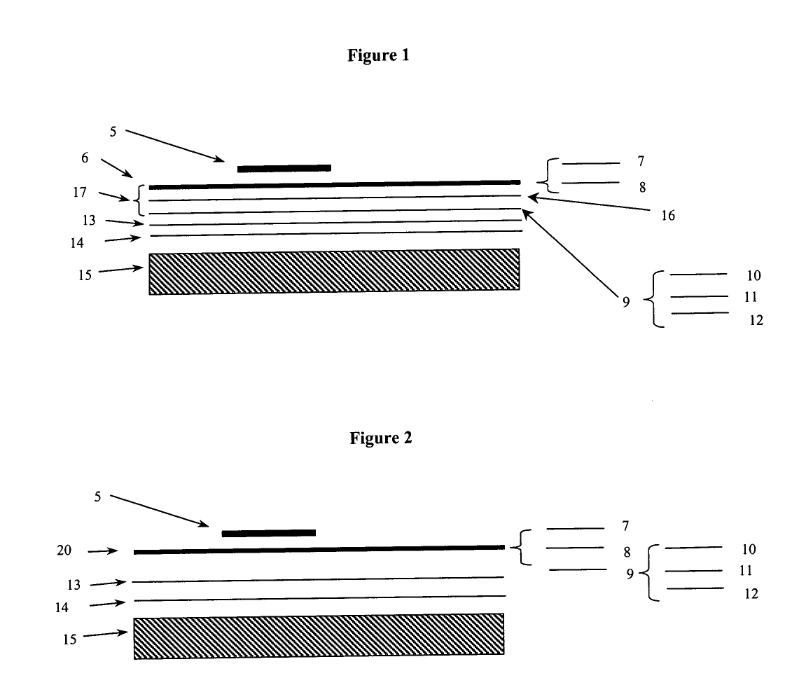

As seen in FIG. 1, a high-pressure laminate construction 17 according to the first embodiment of the present invention is comprised of a susceptor layer 9 bonded to a preformed high-pressure laminate 6 with an adhesive 16. As denoted by brackets, the preformed high-pressure laminate 6 comprises a decorative layer 7 comprising a colored and/or patterned paper sheet impregnated with melamine resin and a laminate core layer 8 comprised of a plurality of stacked sheets, generally from 2-10 layers, of Kraft paper, each impregnated with phenolic resin. Optionally, the preformed laminate 6 may also include a final layer of resin-impregnated tissue or Kraft paper on one or both exposed surfaces of the laminate construction. This optional layer provides added surface durability, especially when applied as an overlayer on the decorative layer, and/or helps to more strongly incorporate the susceptor into the laminate by making the susceptor layer an intermediate layer rather than the bottom surface layer. As indicated by the second bracket, the susceptor layer 9 comprises a susceptor element 12 bonded to a support material 10 with an adhesive 11. The adhesive 11 may be polyethylene or, preferably, especially in the case of metal foils or sheets, an acid-functional ethylene copolymer for improved adhesion to the metal foil. The adhesive 16 bonding the susceptor layer 9 to the preformed laminate 6 may be a thermoset adhesive, a moisture-curing urethane adhesive, a solvent-based contact adhesive, a water-based adhesive such as a polyvinyl acetate emulsion as well as any adhesive used to bond the whole of the assembly to a substrate.

Various configurations of the first embodiment of the present invention may also be made. For example, there may be intermediate layers between the laminate core and the susceptor layer. Such intermediate layers may be, for example, heat insulating layers which protect the laminate core from the heat generated by the susceptor layer. Such intermediate layers must be transparent to electromagnetic energy, i.e., they do not reflect or substantially absorb electromagnetic energy. Additionally, the high-pressure laminates according to the first embodiment may have a heat activatable adhesive layer 13 bonded, directly or indirectly, to the exposed surface of the susceptor layer. There may be additional layers between the susceptor layer and the adhesive layer provided that these intermediate layers are heat transmissive so that the heat generated by the susceptor layer passes through the intermediate layer to the heat activatable adhesive layer. Additionally, where the heat activatable adhesive layer is present, a removable film of release paper, polymer, wax paper or the like 14 may overlay the exposed surface of the adhesive layer to prevent premature bonding of the high pressure laminate to each other or another substrate.

Induction bondable high-pressure laminate constructions of the first embodiment are made by preparing the preformed high-pressure laminate using conventional high-pressure lamination techniques and bonding to the same a preformed susceptor layer. In one step of the production, the assembly of impregnated core and decorative layers, as well as any other layers incorporated or to be incorporated into the laminate, are consolidated under high pressure and heat to compress the assembly, forcing out any voids or trapped air, and cure the resins. In another step, the susceptor layer is prepared by adhering the susceptor element to a support layer so that it can be easily handled, cut to size, etc. The susceptor layer is then bonded using an adhesive to the lower surface of the preformed laminate core 8, i.e., that surface opposite the decorative layer 7.

In accordance with the second and preferred embodiment of the present invention, the susceptor layer is incorporated into the laminate assembly during its manufacture. In this embodiment, as shown in FIG. 2, the high pressure laminate assembly 20 comprises a decorative layer 7 comprising a decorative sheet, preferably a paper sheet, impregnated with melamine resin, a laminate core layer 8 comprising a plurality of sheets of Kraft paper, generally 2-10 layers, impregnated/saturated with a phenolic resin, and a susceptor layer 9 comprising the susceptor element 12 bonded to a support layer 10 with an appropriate adhesive 11. Optionally, a final layer of resin-impregnated tissue or Kraft paper may be laid upon the decorative layer and/or the susceptor layer prior to consolidation of the assembly into the high-pressure laminate.

Additionally, there may be an appropriate adhesive intermediate the Kraft paper and the susceptor layer. Preferably, the use of adhesives to bond the susceptor layer to the core layer, or at least the bottom impregnated sheet of the core layer, is to be avoided. Such adhesives may result in poor adhesion and/or voids as a result of off-gassing from the adhesive itself. Instead, the resin matrix of the core layer itself will serve to bond the susceptor layer to the core layer. Though not necessary, such bonding is or may be enhanced when the susceptor layer has channels, perforations, cut-outs, or punch-outs that allow the resin to infiltrate the susceptor layer or is discontinuous or fails to cover the whole of the surface of the bottom sheet of the core layer thereby allowing the resin to flow over the edges of the susceptor, encapsulating or partially encapsulating the same. This allows the resin to penetrate and/or encompass the susceptor. Most preferably, the assembly to be consolidated will have an additional layer(s) of resin-impregnated/saturated Kraft paper or tissue paper laid over the susceptor layer, sandwiching the susceptor layer between the laid-up stack of Kraft paper and the additional layer(s). The stacked assembly is then heated under high pressure to cure the resins and consolidate the layers into a laminate structure that incorporates the susceptor layer. The foregoing sequence of construction of the pre-laminate, i.e., the stack, is not critical. For example, the stack may be constructed from the lower surface up, the top surface down or by assembling the primary stack of Kraft paper and then completing each side.

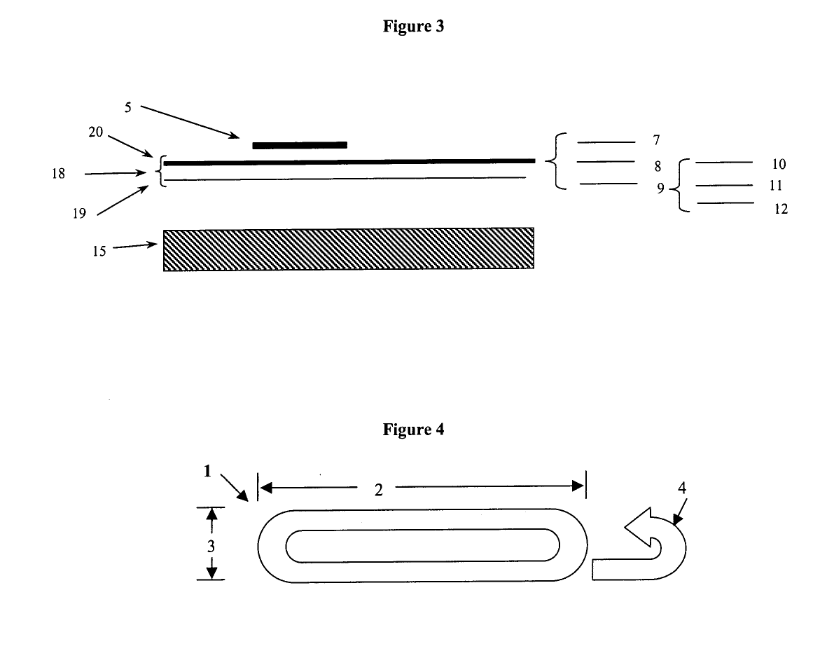

As with the first embodiment, the second embodiment may include intermediate layers between the Kraft paper of the laminate core and the susceptor layer. For example, an appropriate heat-insulating layer may be inserted into the construction prior to forming the laminate. Additionally, as seen in FIG. 3, the so-formed high-pressure laminate construction 92 incorporating the susceptor 9 may have a pre-applied heat responsive adhesive layer 19 bonded, directly or indirectly, to the lower surface of the laminate, i.e., that surface proximate to the susceptor layer, resulting in a ready to use induction bondable high-pressure laminate construction 18. In those embodiments where one or more additional layers of materials are on top of the susceptor layer, opposite the core layer, and/or between the pre-formed laminate and the adhesive layer, it is critical that such layers are heat passive or transmissive so that the heat generated by the susceptor layer passes through such layer(s) to the heat responsive adhesive with minimal, if any, loss. Additionally, where the heat activatable adhesive layer is present, a removable film of release paper, polymer, wax paper, or the like 14 (in FIG. 2) may overlay the exposed surface of the adhesive layer to prevent premature bonding of the high pressure laminate to each other or another substrate.

The high-pressure laminates of this second embodiment are made in accordance with conventional methods for the preparation of high-pressure laminates with the exception that in the assembly process of the stack to be consolidated, a susceptor layer is added to the stack, so as to serve as or be proximate to one surface of the high-pressure laminate: the decorative layer serving as or being proximate to the other surface. As noted, the assembly of stacked layers is then subjected to high pressure and temperatures to create the high pressure laminate 6. If desired, a heat responsive adhesive is then applied to the surface of the laminate defining or proximate to the susceptor. Additionally, a release layer may then be applied to the adhesive or the adhesive and release layer may be applied as a preformed layer.

The high-pressure laminates formed in accordance with either of the foregoing embodiments may be bonded to an appropriate substrate using electromagnetic energy. With those embodiments having a pre-applied heat-responsive adhesive, the so-formed laminate is placed upon the substrate, properly positioned and then exposed to electromagnetic energy suitable for the chosen susceptor and laminate construction. Alternatively, if the adhesive is not already present, a heat-responsive adhesive is applied to either the substrate or the lower surface of the high pressure laminate (i.e., that surface comprising the susceptor), or both, then placed upon the substrate, properly positioned and finally exposed to electromagnetic energy suitable for the chosen susceptor and laminate construction. For optimum performance, it is recommended that pressure be applied to the laminate during or immediately following exposure to the electromagnetic energy so as to ensure a good surface contact and bonding.

If the heat-responsive adhesive selected for bonding the high-pressure laminate to the substrate is a hot melt or other thermoplastic type adhesive, the bonded laminate may be removed by exposing the bonded structure to the appropriate electromagnetic energy so as to soften or melt the adhesive and remove the high-pressure laminate.

An example of an induction apparatus, or tool, useful for heating the metal susceptor is described in Riess et al. (U.S. Pat. No. 6,509,555), incorporated herein by reference. The electromagnetic energy necessary for heating the susceptor so as to affect the induction bond or debonding is generated by the induction coil element of the tool. Preferably, the coil element for use in bonding laminates is of the pancake type, i.e., a flat coil whose height is merely defined by the diameter of the wire or other material used to wind the coil. The coil shape may be circular, elliptical, etc., with a more elliptical shape as shown in FIG. 4 preferred. Specifically, FIG. 4 shows the footprint of an elliptical pancake coil 1 having a given length 2 and width 3. In use, an electric current is passed through the coil in the direction of arrow 4, which creates an electromagnetic field around the coil element, with the field strongest directly above and below the coil element. In one embodiment, the coil consists of 186 inches of Litz wire wrapped into 8 planar turns forming a pancake coil measuring 3½ inches wide and 11 inches long. The size of the footprint of the coil determines, for the most part, the bond area that may be effected with any single operation of the tool. Thus, for larger or smaller areas a larger or smaller coil may be used, and this changes the length of Litz wire required.

Two types of susceptor heating methods could be used: induction/eddy current and hysteretic, which, at least for the purpose of this discussion, includes microwave heating. Induction, or eddy current, heating arises from resistive losses in an electrically conductive susceptor due to currents induced in the susceptor by the drive coil in the tool. Effective eddy current heating requires that the susceptor cover a substantial fraction of the footprint of the drive coil because the induced currents mirror the drive coil currents. In addition, the induced currents and heating increase with frequency up to an optimum frequency, above which the induced currents and heating decline. This optimum frequency is a function of the susceptor thickness and resistivity, the coil configuration and footprint, and separation from the susceptor to the coil. Induction or eddy current heating is not very effective for heating particulate and fiber susceptors or susceptors that subtend only a small fraction of the drive coil footprint.

Hysteretic heating results from the energy loss experienced in a ferromagnetic susceptor as the susceptor is cycled from one direction of magnetization to the reverse direction and back again. Hysteretic heating depends on the coercivity of the susceptor material, the magnitude of the magnetic field that the drive coil generates at the susceptor, and the frequency of the magnetic field reversals. The heating increases directly with frequency and is unaffected by the size of the susceptor or its electrical resistivity. Hysteretic heating can be effective for particulate, fiber, and electrically insulating susceptors that are difficult to heat with induction. If the susceptor is ferromagnetic, electrically conductive, and subtends a significant fraction of the coil footprint, then a combination of eddy current and hysteretic heating will

Depending on the materials to be used and the thickness of the material to be heated, frequencies as low as about 2 kHz can be effective in transferring power to a susceptor. Similarly, frequencies as high as tens of Gigahertz, even up to 100 GHz, can be employed to effectively transfer power to a susceptor. Thus, in its broadest aspect, induction bonding of the laminate constructions of the present invention may be accomplished by electromagnetic energy of low frequency, medium frequency, high frequency and microwave. For induction heating, the frequency is typically in the range of 2 kHz to 10 MHz, but is preferably below 1 MHz, most preferably from about 50 kHz to about 400 kHz.

The induction tool described by Riess et al. is designed to operate in the lower frequency range, below 1 MHz and preferably in the range of 50 kHz to 400 kHz where induced eddy currents generate most, if not all, of the heat in extremely thin metal foils.

The advantages of induction heating are most obvious with heat-reworkable adhesives, such as hot melts, which allow a laminate to be removed from the base as well as installed onto the base. However, induction heating can also be used with adhesives that are not reworkable. Induction heating can be used to initiate, advance, or complete the curing of thermoset adhesives, or accelerate or complete the drying of water-based adhesives. These types of adhesives would provide increased heat resistance to the laminate construction.

The method for bonding the laminate to the base requires the laminate, adhesive, and base to be stacked, with the coil above the laminate, over the hidden metal susceptor, and preferably not extending beyond the edge of the susceptor. The tool is triggered one or more times to generate sufficient heat in the susceptor which, in turn, traverses to the heat responsive adhesive, thereby activating or melting the same. In industrial applications, the coil element may be approximately the same size as the laminate, thereby allowing a single station for bonding. Alternatively, the tool and coil may be of the same width as the laminate or susceptor layer, but not the length. In this instance, the laminate construction is advanced a distance equal to or slightly less than the activation length of the tool, i.e., that distance equal to the length of susceptor able to be activated by the coil. The tool is activated or triggered with each advancement of the laminate construction to effectuate a full bond. A tool such as the one shown in FIG. 1, is intended for hand-held use and is triggered one or more times and moved over the surface of the laminate to melt the adhesive located between the susceptor and the base. An alternate method consists of simultaneous activation and movement of the tool parallel to the surface. If the susceptor consists of thin strips or discrete sections (such as circles or squares) they should be activated with a drive coil whose footprint more closely matches the shape and size of the susceptor. For large laminates, it is desirable to have a means of applying uniform pressure to the laminate until the adhesive sets, for example by temporarily inserting rigid material between the coil and the laminate.

The method for removing the laminate from the base is similar except that the laminate is pried or pulled off after induction heating breaks the adhesive bond. For large laminates, especially those having a sheet susceptor, the tool is used to start melting adhesive on one edge of the laminate and is sequentially moved towards the other sides until the whole laminate is removed. Where the susceptor is not incorporated into the high-pressure laminate but is bonded to a preformed high-pressure laminate, it is preferred that in the adhesive bonding the one to the other is a thermoset adhesive or non-reversible adhesive so as to ensure that the susceptor layer is removed with the laminate. Where a hot melt is used, it is then preferred to use a hot melt having a higher, preferably a markedly higher, melt point or temperature, or a much thicker layer of adhesive, preferably the former.

Because the susceptors are hidden from view during the bonding of the high-pressure laminate to a substrate and it is important to properly orient the source of the electromagnetic energy relative to the susceptors, it may be desirable, if not preferred or even necessary in some instances, to use a template which overlays the high-pressure laminate, or a portion thereof, and has markings or indicators which identify or correspond to the location of the hidden susceptors or the critical points at which bonding is necessary in order ensure a strong and durable bond between the susceptor and the substrate. Such templates would be especially useful in the case of discontinuous susceptors, particularly where the discrete susceptors are present in set or predetermined pattern or orientation. They would also be useful with either discontinuous or continuous susceptors, where bonding is desired or required at only certain locations of the susceptor(s). In the latter situation, it is not always necessary that a bond be formed over the entire interface between the susceptor in the high-pressure laminate and the substrate surface to affect a strong and durable bond. While the susceptor may be continuous or discontinuous, it is also possible that the heat responsive adhesive be present only at certain points where a bond is to be affected. Thus, the templates could also serve to indicate those points where only the susceptor and heat responsive adhesive are present and/or are to be activated.

Templates suitable for use in the method of the present invention could be of various forms as follows: 1) a rigid template made of plastic, wood or other like material that is substantially non-electromagnetic energy absorbing and has indicators corresponding to the underlying susceptor points, 2) a flexible template made of plastic, paper or fabric, either as a tape or a sheet having indicators corresponding to the underlying susceptor points, 3) removable and/or self-adhering discrete indicators placed or printed on the exposed surface of the high-pressure laminate opposite the position of the susceptor or intended bonding point, e.g., a water washable mark or adhesive label, 4) or a mark that is incorporated into graphics, topology, or geometry of the exposed surface of the high-pressure laminate corresponding to the placement of the underlying susceptor point, e.g., a colored mark, a florescent mark, a mark visible only under special lighting, e.g., black light, etc. The susceptor templates are used by overlaying the high-pressure laminate with the susceptor template, positioning the induction coil over the markings, activating to the tool to effectuate the heating of the susceptor underlying the marking to effectuate the bond. These devices and methods have applications beyond high-pressure laminates, but are especially useful in the bonding of such high-pressure laminates.

In the event the substrate to which the high-pressure laminate is to be bonded is composed of a material that is electromagnetic energy transparent, i.e., allows the passage of the electromagnetic energy, the aforementioned indicators or marks may be present on or in the exposed surface of the substrate (i.e., that surface opposite the bonding surface). Additionally, the susceptors, especially those of the rigid or flexible type, may incorporate a registration mark or key which keys the template to the high-pressure laminate or, as appropriate the substrate, so that it properly overlies the susceptors or points to be bonded. In practice, both the susceptor locator and the high-pressure laminate or the substrate, as appropriate, will have a corresponding key such that when the two registration keys are aligned, the indicators or the markings on the susceptor locator are properly positioned over the susceptors or the points to be bonded. The registration key may take many forms including, for example, visible markings or hash marks, corresponding notch and catch or depressions and protrusions, etc. The basis is that the registration key on one aligns in one way or another with the registration key on the other.

Additionally or alternatively, the susceptor locator templates may have a pressure sensitive adhesive present on one surface so that the template, once laid upon the high-pressure laminate, does not move during the bonding process. The template devices could be a single use item that incorporates a heat sensitive agent that changes color or form when the electromagnetic field is applied so as to indicate when and/or where a bond has been affected. Alternatively, the templates could be a reuseable device that also has a heat sensitive chemical incorporated therein to show when a bond has been affected and which returns to its original color upon cooling. It is also possible that the template not be a physical template but a computer program. For example, in robotic or automated assembly operations, the location of the susceptors could be stored electronically, i.e., the location in the bonding plane is calculated and programmed into the robot or computer controlling the source and/or location of the electromagnetic energy generator.

The use of a template is exemplified as follows: a preformed high-pressure laminate strip measuring 2″ by 24″ is made in accordance with the teachings of the present invention. The susceptor layer is discontinuous with individual discrete susceptors located every 4 inches along the strip with the first and last being 2 inches in from each end of the laminate strip. A small depression or notch may be placed in the edge of the laminate strip at or near the point of the first susceptor fastener. To aid in the induction bonding of that laminate strip to a substrate, a contractor could overlay an acrylic ruler (perhaps two or more feet in length) that has a star imprint every 4 inches along its length beginning two inches from its end. To ensure that the template or overlay is properly aligned, the overlay would have a small protrusion that would register or fit with the depression or notch in the edge of the laminate strip. To provide fast bonding with accuracy, the contractor would merely have to match the registration key and then quickly apply the electromagnetic field at each star imprint.

The following examples are provided to further illustrate the invention. These examples are not meant to limit the broad teaching and scope of the invention. Unless otherwise indicated, the induction tool used in the following examples was of the type described in Reiss et. al. (U.S. Pat. No. 6,509,555) using a pancake coil measuring 11 inches by 3.5 inches or 8.5 inches by 3.5 inches, as specified. As the focus of Examples 1 and 2 was to show the bond area attained, a release paper was placed intermediate the adhesive and the substrate prior to activating the tool and effectuating the induction bond.

### EXAMPLES

### Example 1

A high-pressure laminate construction corresponding to the construction set forth in FIG. 2 having incorporated therein a susceptor was prepared. Initially, a high-pressure laminate (20) measuring 8″×11″×1/32″ was manufactured by consolidating the following: a decorative sheet (7), several layers of phenolic resin impregnated Kraft paper (8) with a bottom susceptor layer (9) consisting of 30-pound Kraft paper (10) bonded with polyethylene adhesive (11) to a sheet of aluminum foil (12) 0.000285″ thick. An 8″×11″×0.002″ sheet of Bemis 6219, a dry film ethylene-vinyl acetate adhesive (13), was placed on medium density fiberboard (15) with a sheet of release paper (14) intermediate the two. The laminate (20) was placed on the adhesive film with the foil (12) in contact with the adhesive (13). An induction tool with a coil (5) having a footprint as shown in FIG. 4 measuring 11 inches by 3.5 inches was centered over the laminate. The tool was activated at a setting of 500 Watts and 3000 Joules (approximately 6 seconds). The laminate was removed from the release paper. The area of melted adhesive was 25 square inches.

### Example 2

A high-pressure laminate construction corresponding to the construction set forth in FIG. 2 having incorporated therein a susceptor was prepared. Initially, a high-pressure laminate (20) measuring 8″×11″×1/32″ was manufactured by consolidating the following: a decorative sheet (7), several layers of phenolic resin impregnated Kraft paper (8) with a bottom susceptor layer (9) consisting of 30-pound Kraft paper (10) bonded with polyethylene adhesive (11) to a sheet of aluminum foil (12) 0.000285″ thick. An 8″×11″×0.002″ sheet of Bemis 6219, a dry film ethylene-vinyl acetate adhesive (13), was placed on medium density fiberboard (15) with a release paper (14) intermediate the two. The laminate was placed on the adhesive film with the foil in contact with the adhesive. An induction tool with a smaller coil (8½″×3½″) was centered over the laminate. The tool was activated at a setting of 500 Watts and 3000 Joules (approximately 6 seconds). The laminate was removed from the release paper. The area of melted adhesive was 17 square inches.

### Example 3

A decorative high-pressure laminate measuring 8″×11″×1/32″ was made with a bottom layer of 40 pound Kraft paper bonded with ethylene-acrylic acid copolymer adhesive to a sheet of aluminum foil 0.000285″ thick, foil side facing outward. The laminate was cut into 1″×4″ pieces. A thin film of Jowat 136 042, a low viscosity polyolefin hot melt adhesive recommended for aluminum/fiberboard bonding, was pre-applied to the foil. Bonding was done in a convection oven at 200° F. for 1 hour. After cooling to room temperature, adhesion to the board was tested by peeling two pieces off the board. Adhesion was sufficient to remove a layer of fiberboard with the laminate. The induction tool with a ferrite U-core described by Riess et al., set at 88 Watts and 78 Joules, was repeatedly activated over the other two pieces until the adhesive bond was weakened so that the laminate could be removed with no damage to the fiberboard, and all the foil remained on the laminate.

### Example 4

A decorative high-pressure laminate measuring 8″×11″×1/32″ was made with a bottom layer of 40-pound Kraft paper bonded with ethylene-acrylic acid copolymer adhesive to a sheet of aluminum foil 0.000285″ thick, foil side facing outward. The laminate was cut into 1″×4″ pieces. A thin film of Jowat 221.00, a medium viscosity polyolefin hot melt adhesive recommended for aluminum/fiberboard bonding, was pre-applied to the foil. Bonding was done in a convection oven at 200° F. for 1 hour. After cooling to room temperature, adhesion to the board was tested by peeling two pieces off the board. Adhesion was sufficient to remove a layer of fiberboard with the laminate. The induction tool with a ferrite U-core described by Riess et al., set at 88 Watts and 78 Joules, was repeatedly activated over the other two pieces until the adhesive bond was weakened so that the laminate could be removed with no damage to the fiberboard, and all the foil remained on the laminate.

### Example 5

A decorative high-pressure laminate measuring 8″×11″×1/32″, was made with a bottom layer of 40-pound Kraft paper bonded with ethylene-acrylic acid copolymer adhesive to a sheet of aluminum foil 0.000285″ thick, foil side facing outward. The laminate was cut into 1″×4″ pieces. One piece was bonded to medium density fiberboard with pre-applied Jowat 136 042. Bonding was done using the induction tool with a ferrite U-core described by Riess et al., set at 224 Watts and 224 Joules. After cooling to room temperature, adhesion to the board was tested by peeling the piece off the board. Adhesion was sufficient to remove a layer of fiberboard with the laminate.

### Example 6

A decorative high-pressure laminate measuring 8″×11″×1/32″, was made with a bottom layer of 40-pound Kraft paper bonded with ethylene-acrylic acid copolymer adhesive to a sheet of aluminum foil 0.000285″ thick, foil side facing outward. The laminate was cut into 1″×4″ pieces. One piece was bonded to medium density fiberboard with pre-applied Jowat 221.00. Bonding was done using the induction tool with a ferrite U-core described by Riess et al., set at 224 Watts and 224 Joules. After cooling to room temperature, adhesion to the board was tested by peeling the piece off the board. Adhesion was sufficient to remove a layer of fiberboard with the laminate.

It should be understood that the foregoing description is only illustrative of the invention. Various alternatives and modifications can be devised by those skilled in the art without departing from the invention. Accordingly, the present invention is intended to embrace all such alternatives, modifications and variances falling within the scope the appended claims.

We claim:

1. An induction bondable high-pressure laminate construction having an exposed upper surface and a lower bonding surface comprising, in the following sequence, a) a decorative layer, b) a core layer and c) a susceptor layer, said susceptor layer being capable of absorbing electromagnetic energy.

2. The high-pressure laminate of claim 1 wherein the laminate core comprises multiple layers of resin-impregnated sheet materials, said sheet materials being paper materials, fabric materials, or a combination of paper material and fabric material.

3. The high-pressure laminate of claim 2 wherein the resin is selected from the group consisting of phenolic resins, melamine resins, resorcinolic resins, and urea resins.

4. The high-pressure laminate of claim 2 wherein the sheet material is a paper material paper.

5. The high-pressure laminate of claim 4 wherein the paper material is Kraft paper.

6. The high-pressure laminate of claim 1 wherein the decorative layer is comprised of the same material as the core layer and has the same or a different surface appearance than the surface of the core layer.

7. The high-pressure laminate of claim 6 wherein the decorative layer has a different surface appearance than the surface of the core layer.

8. The high-pressure laminate of claim 1 wherein the decorative layer is comprised of a material different from that used to construct the core layer.

9. The high-pressure laminate of claim 8 wherein the decorative layer is a melamine impregnated layer.

10. The high pressure laminate of claim 1 wherein the decorative layer further comprises a protective overlayer.

11. The high-pressure laminate of claim 1 wherein the decorative layer comprises a metal foil.

12. The high-pressure laminate of claim 1 wherein the susceptor layer comprises an electromagnetic energy absorbing material selected from the group consisting of a non-perforated metallic foil, a perforated metallic foil, a metallic mesh, metallic fibers, carbon fibers and a polymer material having dispersed therein electromagnetic energy absorbing particles.

13. The high-pressure laminate of claim 12 wherein the susceptor layer further comprises a support layer to which the electromagnetic energy absorbing material is bonded.

14. The high-pressure laminate of claim 13 wherein the support layer is a heat insulating layer and is intermediate the electromagnetic energy absorbing material and the core layer.

15. The high-pressure laminate of claim 13 wherein the support layer is selected from the group consisting of paper, tissue, non-woven scrim, and polymer films.

16. The high-pressure laminate of claim 1 wherein a preformed high-pressure laminate is made comprising the decorative layer and the core layer and the susceptor layer is bonded to the preformed laminate.

17. The high pressure laminate of claim 16 wherein the susceptor layer further comprises a pre-applied heat responsive adhesive overlaying all or a part of the susceptor layer, in heat transfer relationship with the susceptor layer, said adhesive applied to the surface of the susceptor layer opposite the surface bonded to the preformed laminate.

18. The high-pressure laminate of claim 17 wherein the heat responsive adhesive is selected from the group consisting of heat activated adhesives, heat reactive hot-melt adhesive and hot-melt adhesives.

19. The high-pressure laminate of claim 16 wherein susceptor layer comprises a heat responsive adhesive material having incorporated therein an electromagnetic energy absorbing material.

20. The high-pressure laminate of claim 19 wherein the adhesive material is a heat activated adhesives, heat reactive hot-melt adhesive and hot-melt adhesives and the electromagnetic energy absorbing material is a particulate material selected from the group consisting of ferrites, metallic flakes, chopped metallic fibers, chopped carbon fibers, carbon black powder, and metallic powder.

21. The high pressure laminate of claim 1 wherein a preformed high-pressure laminate is made comprising the decorative layer, the core layer and the susceptor layer such that the susceptor layer is incorporated into the preformed laminate.

22. The high-pressure laminate of claim 21 further comprising a heat insulating layer intermediate the core layer and the susceptor layer.

23. The high-pressure laminate of claim 21 wherein the preformed laminate further comprises a lower bonding surface made up of one or more layers of a resin-impregnated sheet material, said lower bonding surface being heat transmissive and in a heat transfer relationship with the susceptor layer, opposite the core layer.

24. The high-pressure laminate of claim 21 further comprising a pre-applied heat responsive adhesive, in heat transfer relationship with the susceptor layer, said adhesive applied to the surface of the preformed laminate opposite the exposed upper surface.

25. The high-pressure laminate of claim 24 wherein the heat responsive adhesive is selected from the group consisting of heat activated adhesives, heat reactive hot-melt adhesive and hot-melt adhesives.

26. The high-pressure laminate of claim 1 wherein the susceptor layer is a discontinuous layer comprising a plurality of discrete susceptors, each comprising an electromagnetic energy absorbing material.

27. The high-pressure laminate of claim 26 wherein the discrete susceptors are positioned in a predetermined pattern.

28. The high-pressure laminate of claim 1 wherein the susceptor layer is the only layer capable of absorbing electromagnetic energy and generating heat sufficient to melt an adhesive material.

29. A method of making an induction bondable high-pressure laminate said method being the same as conventional methods for producing high-pressure laminates with the exception that a susceptor layer is inserted into the lay-up of resin impregnated layers either as a surface layer or in close proximity to a surface layer, opposite the decorative layer, if present, during the process of assembling the laminate structure prior to curing or forming the same with heat and pressure.

30. The method of claim 29 further comprising the step of applying a heat responsive adhesive to the surface of the formed high-pressure laminate on the surface thereof comprising or in close proximity to the susceptor layer.

31. A method of forming an induction bondable high-pressure laminate comprising bonding a susceptor to a conventional high pressure laminate to the surface of said laminate opposite the decorative surface layer.

32. The method of claim 31 wherein the method further comprises subsequently applying a heat responsive adhesive to the susceptor layer.

33. A method of bonding an induction bondable laminate to a surface said method comprising applying a heat responsive adhesive to the surface or to the bonding surface of the induction bondable laminate of claim 1, placing the induction bondable laminate on the surface and properly aligning the same for the application, subjecting the induction bondable laminate to electromagnetic energy for sufficient time to activate the adhesive, pressing the laminate into the adhesive and allowing the adhesive to set.

34. The method of claim 33 where the adhesive is a hot melt adhesive and the same sets by cooling and solidifying.

35. A method of bonding an induction bondable laminate to a surface said method comprising placing an induction bondable laminate in accordance with claim 17 on the surface and properly aligning the same for the application, subjecting the induction bondable laminate to electromagnetic energy for sufficient time to activate the adhesive, pressing the laminate into the adhesive and allowing the adhesive to set.

36. A method of bonding an induction bondable laminate to a surface said method comprising placing an induction bondable laminate in accordance with claim 19 on the surface and properly aligning the same for the application, subjecting the induction bondable laminate to electromagnetic energy for sufficient time to activate the adhesive, pressing the laminate into the adhesive and allowing the adhesive to set.

37. A method of bonding an induction bondable laminate to a surface said method comprising placing an induction bondable laminate in accordance with claim 24 on the surface and properly aligning the same for the application, subjecting the induction bondable laminate to electromagnetic energy for sufficient time to activate the adhesive, pressing the laminate into the adhesive and allowing the adhesive to set.

38. A method of removing an induction bondable laminate in accordance with claim 1 from a work surface comprising exposing the laminate to electromagnetic energy for sufficient time to activate the adhesive and pulling the laminate from the work surface.

39. The method of claim 38 wherein the adhesive is a hot melt adhesive and activation means melting the adhesive.
